(19) United States
(12) Patent Application Publication
(10) Pub. No.: US 2024/0162710 A1
(43) Pub. Date: May 16, 2024

(54) PROBABILISTIC CAPACITY PLANNING IN A POWER SYSTEM

(71) Applicant: Quanta Technology, LLC, Raleigh, NC (US)

(72) Inventors: Khashayar Mahani, Brooklyn, NY (US); Farnaz Farzan, Livingston, NJ (US); Ralph David Masiello, Carson City, NV (US)

(21) Appl. No.: 18/505,225

(22) Filed: Nov. 9, 2023

Related U.S. Application Data
(60) Provisional application No. 63/423,915, filed on Nov. 9, 2022.

(51) Int. Cl. H02J 3/14

(52) U.S. Cl. CPC H02J 3/144

(57) ABSTRACT

A method is disclosed for distributed energy resource (DER) and/or electrification capacity planning in a power system. The method includes obtaining, for each of multiple electrical nodes in a circuit model of the power system, parameters of a probability distribution function describing respective probabilities of different amounts of DERs and/or electrification being added at the electrical node. The method further comprises calculating an existing hosting capacity of the power system and/or infrastructure requirements to achieve a target hosting capacity of the power system, by solving an optimization problem that is subject to a reasonability constraint. The reasonability constraint constrains a distribution of amounts of DERs and/or electrification added at respective electrical nodes to being within a space of reasonable distributions which, according to the obtained parameters, each are within a defined confidence level. The method may also comprise reporting information associated with the existing hosting capacity and/or the infrastructure requirements.

### RELATED APPLICATIONS

This application claims the benefit of U.S. Provisional Application No. 63/423,915, filed Nov. 9, 2023, the entire contents of which is incorporated herein by reference.

### TECHNICAL FIELD

The present application relates generally to a power system, and relates more particularly to probabilistic capacity planning in such a system.

### BACKGROUND

Distributed energy resources (DERs) refer to a variety of technologies that generate electricity at or near where it will be used. DERs in this regard include non-bulk electric resources on the electric distribution system (e.g., under 33-kV) that produce electricity. DERs may serve a single structure (e.g., a home or business), may be part of a microgrid, or may be directly connected to the distribution system. DERs for example include behind-the-meter generation such as that produced by solar photovoltaic (PV) panels, small wind turbines, and emergency backup generators. DERs further encompass energy storage, such as battery energy storage systems (BESSs) or batteries in electric vehicles. DERs moreover include combined heat and power systems.

DER adoption is increasing. DERs such as solar panels and electric vehicles have become cost-effective for many homeowners and businesses, help reduce customer utility costs, and protect against rising energy costs. Moreover, when connected to the utility grid, DERs can help support delivery of energy to additional customers and reduce electricity losses along transmission and distribution lines.

Electrification is also increasing. Electrification means replacing technologies or processes that use fossil fuels, like internal combustion engines and gas boilers, with electrically-powered equivalents, such as electric vehicles or heat pumps. These replacements are typically more efficient, reducing energy demand, and have a growing impact on emissions as electricity generation is decarbonized, but will increase local electric power demand as they substitute fossil fuel derived energy with electric energy.

While DERs and electrification provide numerous benefits, they also introduce challenges for a power system. A power system only has the capacity to host a certain amount of additional DERs and/or electrification before reliability becomes problematic, e.g., in terms of overload or outages. A power system's hosting capacity may thereby be characterized as the amount of a DER technology or of new electrification load that the power system can interconnect without risking overloads or outages. To accommodate additional amounts of DERs and/or electrification above the power system's hosting capacity, infrastructure upgrades are required. To determine a power system's existing hosting capacity, or to determine what infrastructure upgrades may be required to achieve a target hosting capacity, utilities must engage in hosting capacity analysis as part of DER and/or electrification capacity planning.

Hosting capacity analysis is complicated by the fact that a power system's hosting capacity depends on not only the amount of DERs and/or electrification added but also the location of the DERs and/or electrification. FIG. 1 shows an example with respect to DERs in the form of photovoltaic (PV) energy resources. On one end of the spectrum of possible values for hosting capacity, a maximum PV penetration level would represent a PV penetration level above which problems in the power system will certainly occur. Deeming this maximum PV penetration level as the power system's hosting capacity, however, would not reflect some problems that might occur with lesser PV penetration levels depending on the locational distribution of PV. On the other end of the spectrum, then, the minimum PV penetration level would represent a PV penetration level below which the power system is safe from problems, no matter the locational distribution of that PV. Deeming this minimum PV penetration level as the power system's hosting capacity proves ideal, but challenging.

A so-called ADHCAT approach in this regard calculates hosting capacity as the minimum amount of DER which, if distributed worst-case, will cause a violation of a reliability limit. To do so, a limited number of Monte Carlo simulations of random DER distributions are performed until a limit is violated. The approach then picks the case with the minimum total DER and deems the hosting capacity as this minimum total DER. Although this approach realistically represents the randomness of DER distribution, it requires a large number of simulations to converge and therefore requires large compute times. Furthermore, as shown in FIG. 2, the ADHCAT approach still fails to approach the true minimum DER penetration level. Indeed, given the vast number of permutations of DER distributions, a Monte Carlo simulation cannot approach the minimum.

Challenges therefore exist to calculate hosting capacity and infrastructure upgrade requirements in a realistic way with reasonable compute times.

### SUMMARY

Embodiments herein provide distributed energy resource (DER) and/or electrification capacity planning in a power system. The capacity planning is notably probabilistic in nature in that it exploits probabilities of different amounts of DERs and/or electrification being added at respective electrical nodes in the system, e.g., with a normal or Gaussian distribution. The probabilistic nature of the capacity planning advantageously enables closed-form calculation of existing hosting capacity and/or infrastructure requirements to achieve a target hosting capacity, e.g., by solving an optimization problem that is subject to a reasonability constraint which constraints the solution to reasonable DER or electrification distributions that are within a defined confidence level. Some embodiments thereby provide hosting capacity analysis without the need for extensive and tedious random simulations, e.g., via Monte Carlo, so as to significantly improve hosting capacity compute time and computational efficiency. Some embodiments furthermore provide hosting capacity analysis that is more accurate and likely to reflect future DER and/or electrification adoption behavior, e.g., in that it is able to more accurately approach the minimum DER and/or electrification penetration level that would cause power system problems irrespective of DER and/or electrification distribution.

More particularly, embodiments herein include a method (e.g., performed by computing equipment) for distributed energy resource (DER) and/or electrification capacity planning in a power system. The method comprises obtaining, for each of multiple electrical nodes in a circuit model of the power system, parameters of a probability distribution function describing respective probabilities of different amounts of DERs and/or electrification being added at the electrical node in the future. The method also comprises calculating an existing hosting capacity of the power system and/or infrastructure requirements to achieve a target hosting capacity of the power system, by solving an optimization problem that is subject to a reasonability constraint. In some embodiments, the reasonability constraint constrains a distribution of amounts of DERs and/or electrification added at respective electrical nodes to being within a space of reasonable distributions which, according to the obtained parameters, each are within a defined confidence level. In some embodiments, a hosting capacity of the power system is a capacity of the power system to host additional amounts of DERs and/or electrification. The method also comprises reporting information associated with the existing hosting capacity and/or the infrastructure requirements.

Other embodiments herein include a non-transitory computer readable medium on which is stored instructions. When executed by computing equipment the instructions cause the computing equipment to obtain, for each of multiple electrical nodes in a circuit model of the power system, parameters of a probability distribution function describing respective probabilities of different amounts of DERs and/or electrification being added at the electrical node in the future. The instructions also cause the computing equipment to also calculate an existing hosting capacity of the power system and/or infrastructure requirements to achieve a target hosting capacity of the power system, by solving an optimization problem that is subject to a reasonability constraint. Here, the reasonability constraint constrains a distribution of amounts of DERs and/or electrification added at respective electrical nodes to being within a space of reasonable distributions which, according to the obtained parameters, each are within a defined confidence level. The hosting capacity of the power system is a capacity of the power system to host additional amounts of DERs and/or electrification. The instructions further cause the computing equipment to also report information associated with the existing hosting capacity and/or the infrastructure requirements.

Embodiments herein further include computing equipment, e.g., comprising processing circuitry, configured to perform the method described.

### BRIEF DESCRIPTION OF THE DRAWINGS

FIG. 1 is a spectrum of photovoltaic (PV) penetration associated with hosting capacity.

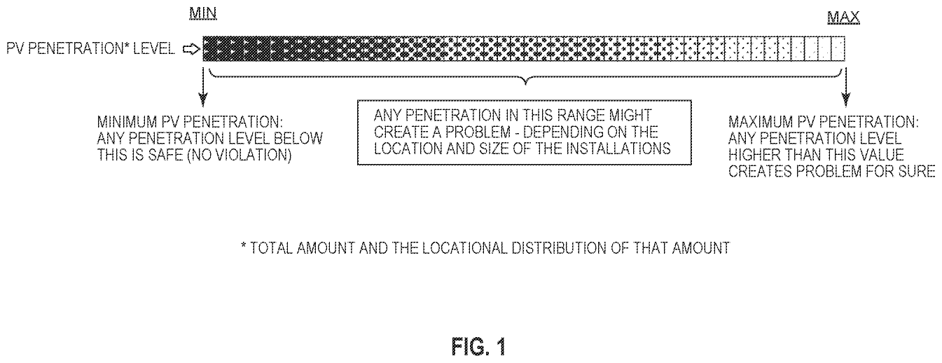

FIG. 2 is a spectrum of PV penetration calculated as hosting capacity by ADHCAT approaches.

FIG. 3 is a block diagram of a power system according to some embodiments.

FIG. 4 is a block diagram of a circuit model of a power system, with electrical nodes that are each associated with a probability distribution function describing respective probabilities of different amounts of DERs and/or electrification being added at the electrical node in the future, according to some embodiments.

FIG. 5 is a block diagram of DER and/or electrification capacity planning according to some embodiments.

FIG. 6A is a block diagram of DER and/or electrification capacity planning that calculates existing hosting capacity according to some embodiments.

FIG. 6B is a block diagram of DER and/or electrification capacity planning that calculates infrastructure requirements to achieve a target hosting capacity according to some embodiments.

FIG. 7 is a spectrum of PV penetration calculated as hosting capacity according to embodiments herein.

FIG. 8 is a graph of a space of reasonable distributions according to some embodiments.

FIG. 9 is a block diagram of a distribution feeder for an exemplary calculation of a maximum/minimum hosting capacity according to some embodiments.

FIG. 10 is a block diagram of the concentration of the majority of the PV adoption in both Minimum and Maximum HC problems according to some embodiments.

FIG. 11 is a block diagram of the location of the majority of PVs in the worst-case PV distribution according to some embodiments.

FIG. 12 is a block diagram of EV loads being located at the end of the feeder which has the highest impact on nodal voltage and line current according to some embodiments.

FIG. 13 is a logic flow diagram of a method for DER and/or electrification capacity planning according to some embodiments.

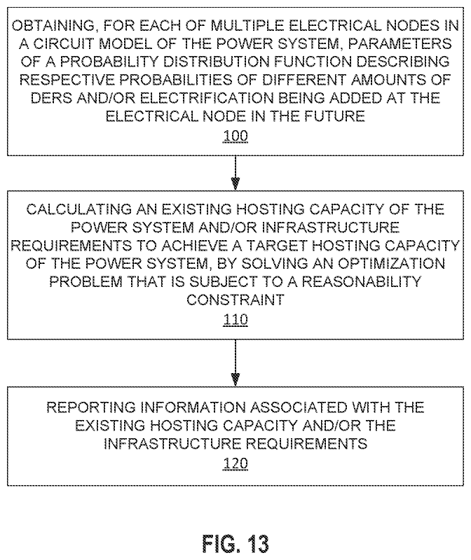

FIG. 14 is a block diagram of computing equipment configured to perform the method of FIG. 13 according to some embodiments.

### DETAILED DESCRIPTION

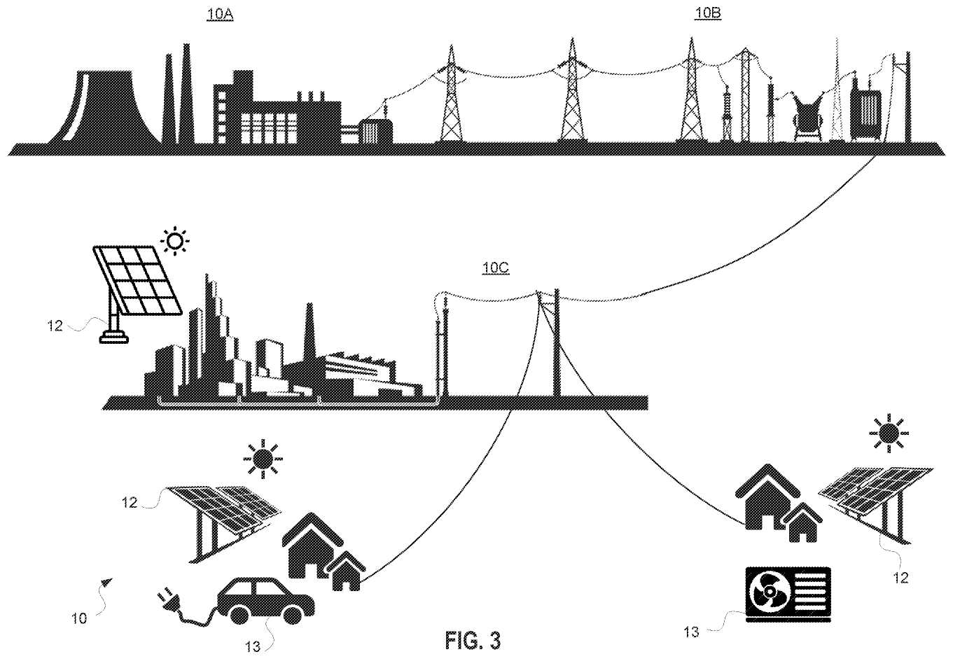

FIG. 3 shows a power system 10 according to some embodiments, e.g., in the form of an electric utility system. The power system 10 as exemplified includes a power generation system 10A, a power transmission system 10B, and a power distribution system 10C. The power distribution system 10C may include distributed energy resources (DERs) 12, shown in the form of solar photovoltaic arrays. The power distribution system 10C may alternatively or additionally include electrification 13, shown in the form of electric vehicles (EVs) and/or heat pumps.

The existing hosting capacity of the power system 10 as used herein is the existing capacity of the power system 10 to host additional amounts of DERs 12 and/or electrification 13, e.g., above and beyond any DERs 12 and/or electrification 13 already hosted. That is, the power system 10 with its current infrastructure has the capacity to support or accommodate additional amounts of DERs 12 and/or electrification 13 before electrical limits for the power system 10 are violated so as to jeopardize reliability. For example, the existing hosting capacity may include a capacity of the power system 10 to host additional amounts of Photo Voltaic (PV) energy resources and/or Electric Vehicle (EV) energy resources. Increasing the existing hosting capacity of the power system 10 to some target hosting capacity would require infrastructure upgrades, e.g., additional battery energy storage systems (BESSs) of a certain size and/or other non-wire alternative (NWA) infrastructure may need to be deployed at certain location(s).

Embodiments herein concern DER and/or electrification capacity planning in the power system 10. This planning may involve calculating the existing hosting capacity of the power system 10, e.g., in order to better understand whether and/or when infrastructure upgrades may be required given estimated DER and/or electrification adoption rates. Alternatively or additionally, this planning may involve calculating infrastructure requirements to achieve a target hosting capacity, e.g., in order to better understand the required extent of infrastructure upgrades that would be needed to achieve a certain target hosting capacity above the existing hosting capacity.

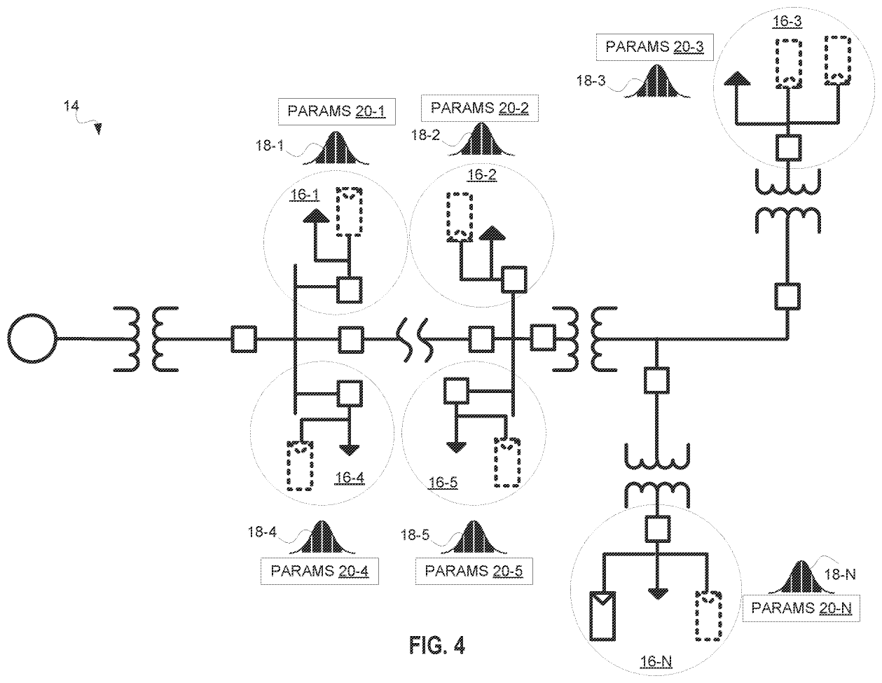

FIG. 4 illustrates a circuit model 14 of the power system 10 for use in DER and/or electrification capacity planning according to some embodiments. As shown, the circuit model 14 has multiple electrical nodes 16-1 . . . 16-N, referred to generally as electrical nodes 16. Different electrical nodes 16 may reflect different locations in the power system 10. Embodiments herein recognize that at least some different electrical nodes 16 may have different DER and/or electrification adoption behaviors or tendencies, so as to have different probabilities of DERs 12 and/or electrification 13 being added in the future.

To capture this for purposes of capacity planning, and to enable a closed-form solution for capacity planning, some embodiments herein advantageously associate each electrical node 16-1 . . . 16-N with a respective probability distribution function 18-1 . . . 18-N. The probability distribution function 18-1 . . . 18-N for an electrical node 16-1 . . . 16-N describes respective probabilities of different amounts of DERs 12 and/or electrification 13 being added at the electrical node 16-1 . . . 16-N in the future. FIG. 4 shows that the probability distribution function 18-1 . . . 18-N for an electrical node 16-1 . . . 16-N can be parameterized with respective parameters 20-1 . . . 20-N of the probability distribution function 18-1 . . . 18-N, for use by capacity planning. These parameters 20-1 . . . 20-N are referred to generally as parameters 20.

Notably, for example, some embodiments treat the probability distribution function 18-1 . . . 18-N at each electrical node 16-1 . . . 16-N as being for a normal or Gaussian probability distribution. In this case, then, the parameters 20-1 . . . 20-N of the probability distribution function 18-1 . . . 18-N at each electrical node 16-1 . . . 16-N may include a mean parameter and a standard deviation parameter, e.g., whose respective values are a mean and standard deviation of the probability distribution function. Alternatively, the parameters 20-1 . . . 20-N of the probability distribution function 18-1 . . . 18-N at each electrical node 16-1 . . . 16-N may include a mean parameter and a covariance parameter, e.g., with the covariance parameter capturing the standard deviation.

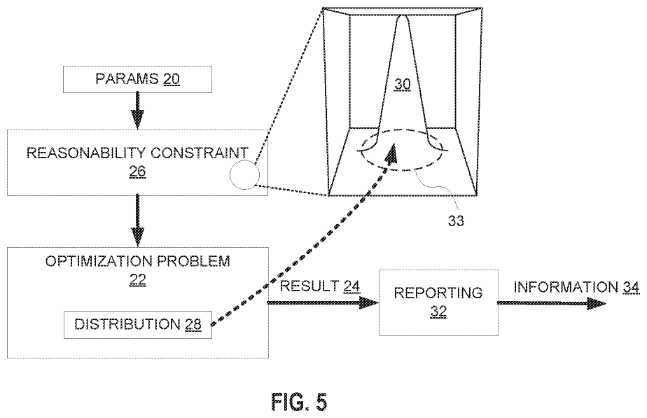

No matter the type or nature of the probability distribution function, though, FIG. 5 shows use of the parameters 20 to calculate the existing hosting capacity of the power system 10 and/or infrastructure requirements to achieve a target hosting capacity of the power system 10. Some embodiments calculate the existing hosting capacity and/or the infrastructure requirements by solving an optimization problem 22, with the result 24 of the optimization problem 22 thereby including the existing hosting capacity and/or the infrastructure requirements. This optimization problem 22 is however subject to a reasonability constraint 24 which is a function of the parameters 20.

More particularly, solving the optimization problem 22 may involve finding a distribution 28 of amounts of DERs 12 and/or electrification 13 added at respective electrical nodes 16 which produces the result 24. The distribution 28 may thereby reflect an amount of additional DERs 12 and/or electrification 13 and how that amount is locationally distributed amongst the electrical nodes 16. The reasonability constraint 26 however constrains this distribution 28 to being within a space 30 of reasonable distributions. The reasonable distributions within this space 30 are distributions which, according to the parameters 20, each are within a defined confidence level 32. Where for example the defined confidence level 32 reflects a 2σ probability, or a 95% probability, the reasonability constraint 26 constrains the distribution 28 to being within a space 30 of distributions which have at least a 95% probability of occurrence. These embodiments thereby advantageously ignore unlikely distributions in solving the optimization problem 22, e.g., in order to achieve a closed-form solution to the optimization problem 22 and/or in order to avoid understating the hosting capacity and prompt infrastructure investments on the basis of the unlikely distribution. Some embodiments accordingly allow a cost-risk tradeoff as a matter of policy and planning

With the result 24 of the optimization problem 24 reflecting the existing hosting capacity or the infrastructure requirements to achieve a target hosting capacity, some embodiments implement reporting 32 of information 34 associated with the existing hosting capacity or the infrastructure requirements. For example, if the result 24 of the optimization problem 24 reflects the existing hosting capacity, the information 24 reported may include information describing the existing hosting capacity in terms of a total additional amount of DERs 12 and/or electrification 13 for which the power system 10 has capacity. Alternatively or additionally, the information 24 reported may include information describing the distribution 28 which provides the existing hosting capacity. As another example, if the result 24 of the optimization problem 24 reflects the infrastructure requirements to achieve a target hosting capacity, the information 34 reported may describe the infrastructure requirements in terms of an amount and/or type of infrastructure required, e.g., a size of BESS required.

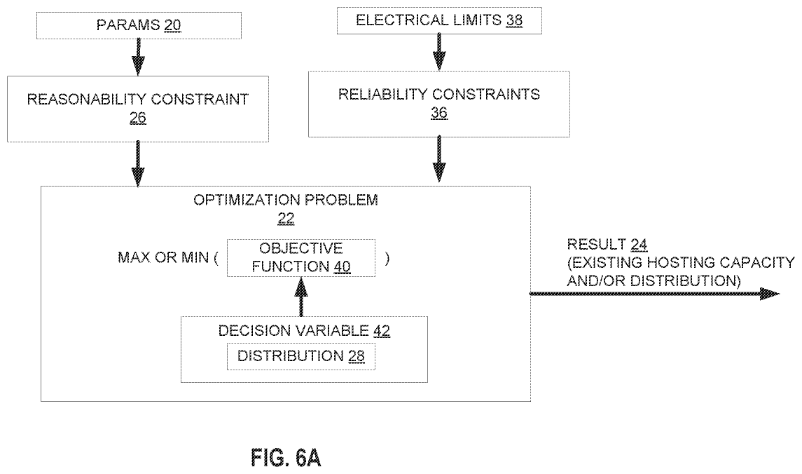

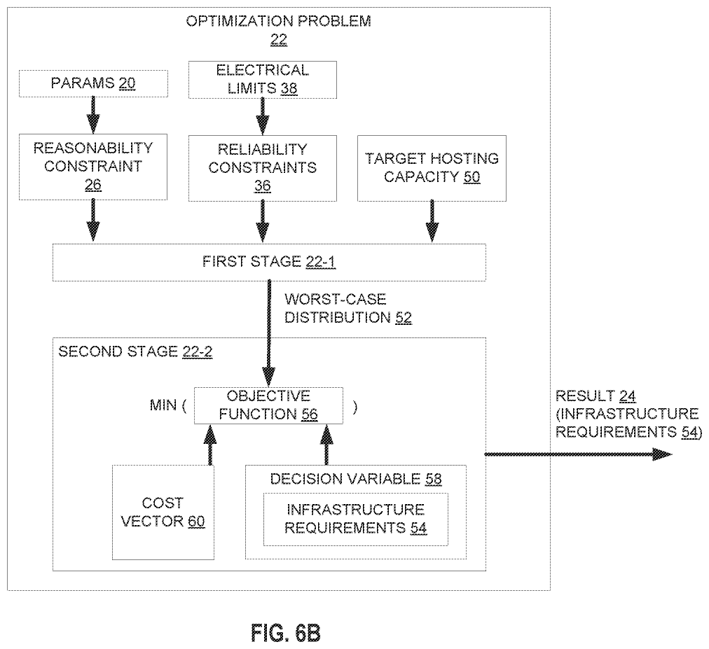

FIG. 6A shows additional details of some embodiments for calculating the existing hosting capacity of the power system 10. In this example, solving the optimization problem 22 involves finding a maximum (MAX) or minimum (MIN) value of an objective function 40, in dependence on the reasonability constraint 26 and multiple reliability constraints 36. The objective function 40 may for instance characterize a total amount of DERs 12 and/or electrification 13 added to the power system 10. In this case, the maximum or minimum value of the objective function 40 is a maximum or minimum total amount of DERs 12 and/or electrification 13 added to the power system 10.

In particular, when considering the DER hosting capacity, solving the optimization problem 22 may involve finding the maximum (MAX) value of the objective function 40, in dependence on the reasonability constraint 26 and the multiple reliability constraints 36, so as to find the maximum total amount of DERs 12 added to the power system 10. By contrast, when considering electrification hosting capacity, injections of electrification are negative to reflect that they are loads. So, solving the optimization problem 22 in this case may involve finding the minimum (MIN) value of the objective function 40, in dependence on the reasonability constraint 26 and the multiple reliability constraints 36, so as to find the minimum total amount of electrification 13 added to the power system 10,

Regardless of whether DER or electrification hosting capacity is calculated, in these and other embodiments, the objective function 40 is a function of a decision variable 42. The decision variable 42 is the distribution 28, i.e., the distribution of amounts of DERs 12 and/or electrification 13 added at respective electrical nodes 16. Solving the optimization problem 22 accordingly involves finding the distribution 28 that maximizes or minimizes the value of the objective function 40. However, the reasonability constraint 26 as described above constraints this distribution 28 to being within the space 30 of reasonable distributions.

Furthermore, the optimization problem 22 as shown also depends on the reliability constraints 36. The reliability constraints 36 enforce electrical limits 38 for the circuit model 14. The electrical limits 38 may for example include a minimum voltage allowed for each of the electrical nodes 16, a maximum voltage allowed for each of the electrical nodes 16, and/or a maximum current allowed for each of multiple branches in the circuit model 14. Alternatively or additionally, the electrical limits 38 may include a backfeed limit, e.g., limiting power flow so that it must be delivered to a feeder.

No matter the particular type or nature of the reliability constraints 36, though, some embodiments herein solve the optimization problem 22 by finding the maximum or minimum value of the objective function 40 such that the reasonability constraint 26 is satisfied and at least one of the reliability constraints 36 is violated. Formulating the optimization problem 22 in this way is notable. Indeed, heretofore, optimization problems in general are formulated to find the minimum or maximum value of an objective function such that all constraints are satisfied. These embodiments by contrast formulate the optimization problem 22 such that at least one of the reliability constraints 36 is violated. That is, from among possible distributions that satisfy the reasonability constraint 26 and violate one or more of the reliability constraints 36, the distribution that maximizes or minimizes the value of the objective function 40 solves the optimization problem 22.

Consider a specific example for calculating existing DER hosting capacity. The objective function in this case may be u^{T}p, where u is a vector of 1 s, where p represents the distribution 28 as a vector of values pᵢ, and where pᵢ is an amount of DER 12 added at electrical node i. In this case, then, the optimization problem 22 may be formulated as min (u^{T}p), such that the reasonability constraint 26 is satisfied and at least one of the reliability constraints 36 is violated. The minimum total amount of DER 12 resulting is then the existing DER hosting capacity.

Consider a specific example implementation of the reasonability constraint 26 in this case. The reasonability constraint 26 may be specified as ((p−pₘ)^{T}Rₚ⁻¹(p−pₘ))≤r′, where pₘ is an expected value E(p) of p, where Rₚ is a covariance matrix equal to E((p−\sqrt{pₘ}) (p−pₘ)^{T}), and where r′ represents the defined confidence level (e.g., 95%). Such a reasonability constraint 26 thereby constraints p in min (u^{T}p) such that ((p−pₘ)^{T}Rₚ⁻¹(p−pₘ))≤r′.

Consider another specific example for calculating existing electrification hosting capacity. The objective function in this case may be u^{T}e, where u is a vector of 1 s, where e represents the distribution 28 as a vector of values eᵢ, and where eᵢ is an amount of electrification 13 added at electrical node i. In this case, then, the optimization problem 22 may be formulated as max(u^{T}e), such that the reasonability constraint 26 is satisfied and at least one of the reliability constraints 36 is violated. The maximum total amount of electrification 13 resulting is then the existing electrification hosting capacity.

Consider a specific example implementation of the reasonability constraint 26 in this case. The reasonability constraint 26 may be specified as ((e−eₘ)^{T}Rₑ⁻¹(e−eₘ))≤r′, where eₘ is an expected value E(e) of e, where Rₑ is a covariance matrix equal to E((e−eₘ) (e−eₘ)^{T}), and where r′ represents the defined confidence level. Such a reasonability constraint 26 thereby constraints e in max (u^{T}e) such that ((e−eₘ)^{T}Rₑ⁻¹(e−eₘ))≤r′.

Regardless of the particular implementation, though, some embodiments solve the optimization problem 22 by defining binary variables for each constraint and formulating a mixed integer programming problem (MIP) with linear and quadratic constraints. Other embodiments solve the optimization problem 22 with a constraint on only one node or branch of the circuit model 14, repeat for all constrained nodes and branches, and select the minimum of the individual minimums (for DERs 12) or the maximum of the individual maximums (for electrifications). That is, solving the optimization problem 22 in this way may involve, for each electrical node and branch in the circuit model 14, solving the optimization problem 22 with a constraint on only that electrical node or branch to obtain an individual maximum or minimum value of the objective function, and then selecting a maximum or minimum value from among the individual maximum or minimum values.

FIG. 6B shows additional details of some embodiments for calculating infrastructure requirements to achieve a target hosting capacity 50 of the power system 10. In this example, the optimization problem 22 is a two-stage optimization problem which includes a first stage 22-1 and a second stage 22-2. The first stage 22-1 calculates a worst-case distribution 52 of an amount of DERs 12 and/or electrification 13 added to the power system 10. The first stage 22-1 does so by calculating the worst-case distribution 52 as a distribution that satisfies the reasonability constraint 26, that maximizes violation of reliability constraints 36, and that achieves the target hosting capacity 50. The worst-case distribution 52 thereby represents the worst possible locational distribution of an amount of additional DERs 12 and/or electrification 13 which would achieve the target hosting capacity 50.

The second stage 22-2 then finds the infrastructure requirements 54 that minimize an objective function 56 and that resolve the maximized violation of the reliability constraints 36. Here, the objective function 56 is a function of the infrastructure requirements 54 and a cost 60 vector. The cost vector 60 characterizes costs of the infrastructure requirements 54. For example, the cost vector 60 may characterizes financial costs of the infrastructure requirements 54, energy savings attributable to the infrastructure requirements 54, energy and ancillaries market benefits of the infrastructure requirements 54, emissions reduction attributable to the infrastructure requirements 54, grid-avoided costs of the infrastructure requirements 54, or any combination thereof.

Consider a specific example for calculating infrastructure requirements 54 for achieving a target DER hosting capacity. In some embodiments, the first stage 22-1 calculates a worst-case distribution p^{worst} that achieves the target hosting capacity 50 by calculating the worst-case distribution p^{worst} as a distribution which satisfies a reasonability constraint 26 which is: ((p^{worst}−pₘ)^{T}Rₚ⁻¹(p^{worst}−pₘ))≤r′, where p^{worst} is the worst-case distribution of an amount of DERs 12 in the power system 10, where pₘ is an expected value E(p^{worst}) of p^{worst}, where Rₚ is a covariance matrix equal to E((p^{worst}−pₘ)(p^{worst}−pₘ)^{T}), and where r′ represents the defined confidence level.

Further in this example, the second stage 22-2 may calculate infrastructure requirements 54 in the form of a BESS size B_{cap}, where B_{cap} is the vector of nodal BESS capacity. The second stage 22-2 in this case may calculate B_{cap} according to

$${min}_{{\underline{B}}_{cap}} ( {\underline{C}}^{T} {\underline{B}}_{cap} ) ,$$

where C is the cost vector 60, subject to resolution of the worst-case violations of the reliability constraints 36.

Consider now specific example implementations of some embodiments herein that target one or more inter-related issues/problems facing the utility industry. One problem is a need to calculate Photo Voltaic (PV) and Electric Vehicle (EV) hosting capacity in a realistic way with reasonable compute times and which reflects the uncertainties around the penetration, size, and location of future consumer adoption of these technologies. Another problem is a need to similarly compute the ability of distribution systems to accommodate “electrification” of existing fossil fired energy use (heating, hot water, stoves, etc.) A further problem is a need to determine how best to invest in grid infrastructure and/or non-wires alternatives such as batteries to increase hosting capacity to deal with expected future needs. Another problem is a need in some jurisdictions to incorporate other economic impacts of grid infrastructure and non-wires alternatives including energy cost savings, energy revenues, ancillaries revenues and impact, emissions reduction, grid avoided costs, and others that can be quantified.

Some embodiments herein address these issues in a probabilistic framework for co-optimization of all resources under consideration in a distribution planning analytics tool that includes accurate and complete modeling of the distribution system.

Some embodiments in this regard provide a methodology for calculating “hosting capacity” (ability of grid to connect with distributed energy resources) for PV, Electrification, EV, and other distributed energy resources (DERs) on a probabilistic basis that provides utilities with a confidence level that the grid can support likely DER adoption in the future without foreknowledge of which customers will adopt what and where. Some embodiments may be characterized in this regard as optimizing a formally developed metric as an expectation of a stochastic process. Some embodiments alternatively or additionally provide a methodology for determining the best investments in grid infrastructure, wires and non-wires, to accommodate increased levels of DER and Electrification beyond the existing hosting capacity. Some embodiments alternatively or additionally provide a methodology to co-optimize “stacked benefits” arising from energy revenues and costs, participation in energy ancillaries markets, emissions reduction, and grid avoided costs.

Certain embodiments may provide one or more of the following technical advantage(s).

One technical advantage of some embodiments is formulation of future DER, Electrification, and EV adoption as a probabilistic function which is then used as a constraint in the optimization process to allow capacity and investment calculations to consider the entire probabilistic space of future penetrations in a mathematically complete form, without the need for extensive and tedious random simulations via Monte Carlo or another approach.

Another technical advantage in some embodiments is formulation of the optimization problem as “find the minimum penetration” which violates at least one feeder constraint (i.e., thermal limits and voltage limits). This contrasts with normal formulations of optimization problems (in general) as being to minimize or maximize an objective function subject to all constraints.

A further technical advantage of some embodiments is the ability to perform the capacity calculations using the probabilistic constraint set to different parameters so as to reflect different confidence levels in the outcome. Alternatively or additionally, a technical advantage of some embodiments is the ability to link the probabilistic constraint to statistics on DER, Electrification, and EV historical adoption OR to bottom-up propensity analysis based on simulations of consumer decision making and adoption forecast estimates. Some embodiments thereby are able to provide a realistic representation of random PV interconnection requests.

Furthermore, some embodiments have a technical advantage of an ability to include additional metrics in the objective function for co-optimized investment decision making including energy, ancillaries, emissions, and grid avoided costs.

Moreover, some embodiments advantageously provide computational efficiency that is significantly (orders of magnitude) superior to other approaches.

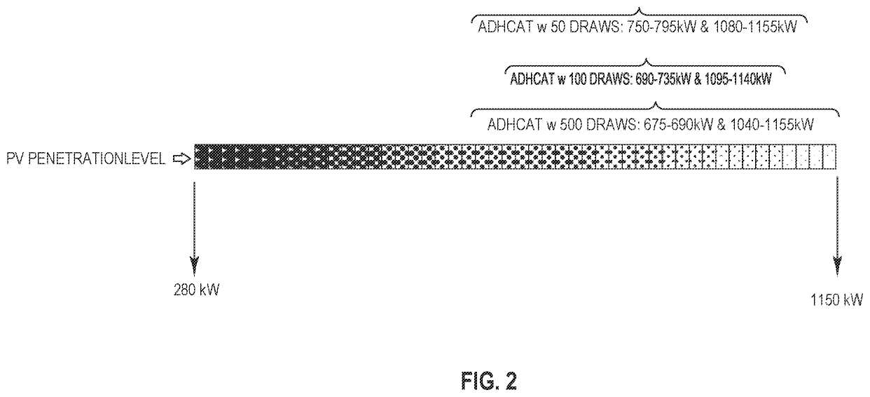

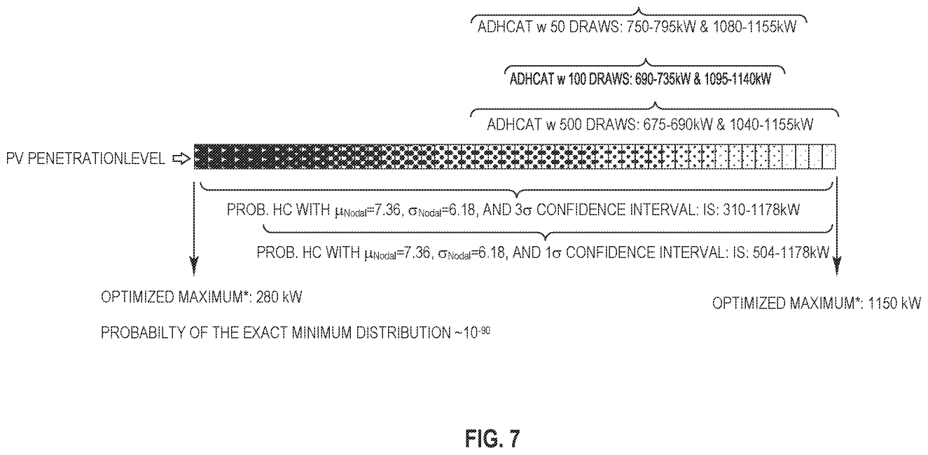

FIG. 7 illustrates another technical advantage of some embodiments as being able to calculate the hosting capacity (HC) in a way that better approaches the minimum PV penetration level, as compared to ADHCAT in FIG. 2. Some embodiments exploit the fact that the probability of the exact minimum distribution is extremely low.

Consider now a detail example embodiment for determining existing hosting capacity of the power system 10.

Determining Hosting Capacity

Step 1 Characterize the Future Penetration of Technology Adoption as Random Variables

Nodal PV adoption/penetration is random both in terms of amount and location. The probability distribution functions and their parameters for Photo Voltaic (PV) adoption and for Electric Vehicle (EV) or Electrification are described below.

Vector of PV at nodes: p where pᵢ is the amount of new PV capacity at node i follows a “Normal” or “Gaussian” probability distribution:

$$P ( \underline{p} ) = \frac{{e}^{- f ( \underline{p} )}}{\sqrt{2 {π}^{N} \vert {R}_{p} \vert}} where f ( \underline{p} ) = \frac{1}{2} ( {( \underline{p} - \underline{{p}_{m}} )}^{T} {R}_{p}^{- 1} ( \underline{p} - \underline{{p}_{m}} ) ) \qquad ( 1 )$$

(2) pₘ=E(p) and Rₚ=E((p−pₘ)(p−pₘ)^{T}) are the mean vector and covariance matrix. Note that p exemplifies the distribution 28 in FIG. 5 according to some embodiments.

“Normal” or “Gaussian” distributions have not until now been applied to the hosting capacity and related problems.

The means and covariances of nodal PV adoption can be adjusted to take into account historical PV adoption statistics (as from interconnection requests) or to utilize bottom-up propensity analysis. Thus, the likelihood of PV adoption can be tailored to each electrical node in the circuit (i.e., service transformer) individually. This can reflect customer type, customer demographics, customer energy usage, etc. The off-diagonal terms of the covariance matrix can be used to incorporate the tendency of PV adoption to occur in neighborhood clusters.

The maximum output of the PV is the capacity for this purpose. The p vector will be used in the optimization step as a positive injection of kW to the grid.

When electrification or EV adoption are considered, an identical formulation is used (with appropriate unique means and covariances) but the vector of injection to the grid is negative reflecting the load they add to the grid.
(3) The expected total PV=u^{T}pₘ (where u is a vector of 1's) is Σᵢpₘ_{ᵢ} just the sum of the means.

Step 2 Incorporate Grid Reliability Constraints which Limit Hosting Capacity

The change in voltage resulting from a single instance of p is given by
(4) Vₘᵢₙ≤V_{base}+Δν≤Vₘₐₓ nodal voltage limits
(5) where Δν=Gₚ*p+G_{q}*q, where Gₚ and G_{q} are the matrices of nodal voltage sensitivities to changes in nodal real and reactive power injection coming from the AC load flow. V_{base} are the nodal voltages pre-existing in base case conditions before PV adoption.

A similar formulation can be written for branch flow changes resulting from PV if back feed or even current overload is a concern:
(6) 0≤I_{base}+Δi≤Iₘₐₓ
(7) where Δi=Hₚ*p+H_{q}*q, where Hₚ and H_{q} are the matrices of nodal current sensitivities to changes in nodal real and reactive power injection coming from the AC load flow. I_{base} are the branch pre-existing in base case conditions before PV adoption. The grid reliability constraints represented by (4), (5), (6), and (7) exemplify the reliability constraints 36 in FIG. 6A according to some embodiments.

Step 3 Formulate the Confidence Factor Constraint

The number of possible locational distributions of PV adoption on a typical distribution circuit are near-infinite. If for instance one hypothesizes that 100 customers out of 400 might adopt PV, ignoring variations in the size of PV adopted there are 400!/(100!*300!) possible locational distributions. The number of combinations of 25 adoptions out of 100 possible is approximately 2*10²³—that for the more realistic 100 out of 400 is too large to calculate—order of 10⁹⁶. The number of atoms in the universe is estimated around 10⁸² so Monte Carlo sampling is challenged to approach it.

A “goal” can be defined for the circuit to accommodate all potential PV adoption that are within a 2σ probability, or a 95% probability, for instance.

A “reasonable” space can be defined by specifying that p(pᵣ)>pᵣ∀r in the space. This would define a convex, continuous space of PV adoption.

This can be restated as

(8) ((p−pₘ)^{T}Rₚ⁻¹(p−pₘ))≤r′ where r′ is given by c2(0.95) or other chosen confidence level, e.g., chi-squared confidence level.
This confidence level constraint in (8) exemplifies the reasonability constraint 26 in FIGS. 5 and 6A according to some embodiments.

This says that any vector p that satisfies this constraint is within the 95% confidence level. Choosing r′ can define the space of “reasonable” p that meets, for instance, a 1, 2 or 3σ level.

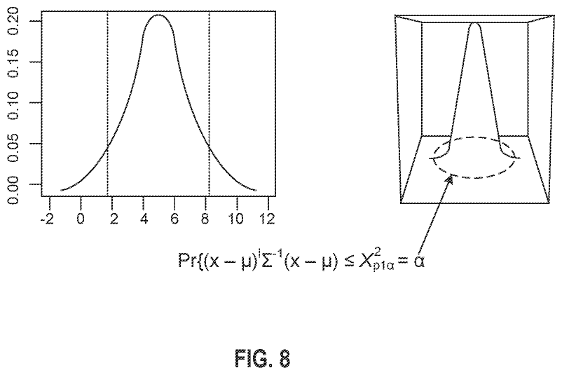

FIG. 8 shows what the probabilistic “reasonability constraint” or “confidence level constraint” means in some embodiments. Here, confidence level is expressed as “no” (# of std dev) or as x % as in 95%, 99.7%). “Alpha” is X² parameter. And confidence level=α. The objective is to stay “in the cone” and avoid the “tails” in the estimation of hosting capacity.

Note that other distributions may be more “realistic” and match historical data more closely, e.g., exponential or bivariate distributions. But these may not exist or be derived readily as multivariate distributions. The advantages of the normal distribution outweigh the problems.

Step 4 Formulate the Hosting Capacity Problem

The hosting capacity has heretofore been defined as the minimum amount of PV which, if distributed worst case, will cause a violation of a reliability limit. This has been attacked until now by performing a limited number of Monte Carlo simulations of PV distributions until a limit is violated and picking the case with minimum total PV. However, the illustration of how many permutations there shows that a Monte Carlo simulation cannot approach the minimum.

This can be formulated in some embodiments herein as an optimization problem:

(9) Find HCmin=min(u^{T}p) (minimize total PV)
such that (8) is met and such that at least one element of either (5) or (6) are violated. This optimization problem in (9) exemplifies the optimization problem 22 in FIGS. 5 and 6A according to some embodiments, with u^{T}p exemplifying the objective function 40 in FIG. 6A.

This formulation is notable. First, the probability density function is used to establish a space of “reasonable” distributions for which it is desired to calculate the hosting capacity. Second, the optimization is posed as finding the minimum which violates at least one constraint. (Typical optimizations are posed as find min or max that observe all constraints—this is the inverse of that.)

Some embodiments thereby provide direct optimization of probabilistic PV distribution for hosting capacity. The Hosting Capacity Constraints (hcc) may be given by:
Voltage upper limit or V_{base}+AV≤Vₘₐₓ or V_{base}+G*p≤Vₘₐₓ (linearized sensitivities)
Line current limit or I_{base}+ΔI≤Iₗᵢₘ or I_{base}+H*p≤Iₗᵢₘ (linearized sensitivities)
for all draws of p in a “reasonable” space
   Given the definition of “reasonable” space—what is the Minimum/Maximum p that can be hosted for a given probability space of PV distributions—90%, 95%, 98%, etc.

Some embodiments may be based on one or more of the two following optimization problems.

One optimization problem finds the minimum hosting capacity, to minimize “Total amount of PV” (Decision variables: nodal PV), subject to: (i) at least one of the following constraints is violated: Voltage constraints (V_{base}+G*p≤Vₘₐₓ), current constraints (I_{base}+H*p≤Iₗᵢₘ), and backfeed constraints; (ii) reasonable Space constraints (βp^{T}*Rₚ⁻¹*βp)≤p′: and (iii) Nodal PV limit (0≤p≤pₗᵢₘ).

Another optimization problem finds the maximum hosting capacity, to maximize “Total amount of PV” (Decision variables: nodal PV), subject to: (i) Voltage constraints (V_{base}+G*p≤Vₘₐₓ), (ii) current constraints (I_{base}+H*p≤Iₗᵢₘ), (iii) backfeed constraints; (iv) reasonable Space constraints (βp^{T}*Rₚ⁻¹*βp)≤p′; and (v) Nodal PV limit (0≤p≤pₗᵢₘ).

Step 5 Solve the HC Problem

This optimization problem can be solved in one of two ways.

One way (a) is to define binary variables for each constraint and formulate a mixed integer programming problem (MIP) with linear and quadratic constraints.

Another way (b) is to solve the optimization problem with a constraint on only one node or branch, repeat for all constrained nodes and branches, and select the minimum of the individual minimums.

In some contexts, method (b) may be more computationally robust and more efficient. Embodiments herein are exemplified using method (b), but can be extended to method (a) as an alternative.

It is possible to formulate the electrification or EV hosting capacity problem in identical form except that (9) must be rewritten to recognize that these injections are negative; that is “min” becomes “max”.

Step 6 Alternative Calculations

The following alternative calculations are alternative problem formulations.

The maximum possible capacity is given by

(10) find HCmax=max(u^{T}p) such that (5) and (6) are observed.

One constraint in the hosting capacity calculation may be a “backfeed” constraint which says that the power flow at the substation/feeder head cannot be negative—power must be delivered to the feeder. This arises from legacy ground fault protection apparatus at the station transformer. The HC can be calculated with or without this constraint, depending upon the particulars of the given station/feeder.

The absolute minimum HC can be calculated by taking (9) and disregarding (8) so that the entire space of possible distributions is considered.

Step 7 Reporting

At this point, the resulting HC, min and max HC values, with and without backflow constraints, are reported. Alternatively or additionally, the particular PV distributions that resulted in each result, and statistics (minimum and maximum nodal PV, mean and standard deviation) on each, may be reported. Reporting may involve, for example, the computing equipment transmitting the reported information to other equipment and/or providing the reported information to one or more components of the computing equipment for display or further processing. The information reported in Step 7 may exemplify the information 34 reported in embodiments of FIG. 6A.

### Illustrative Example—Minimum/Maximum HC

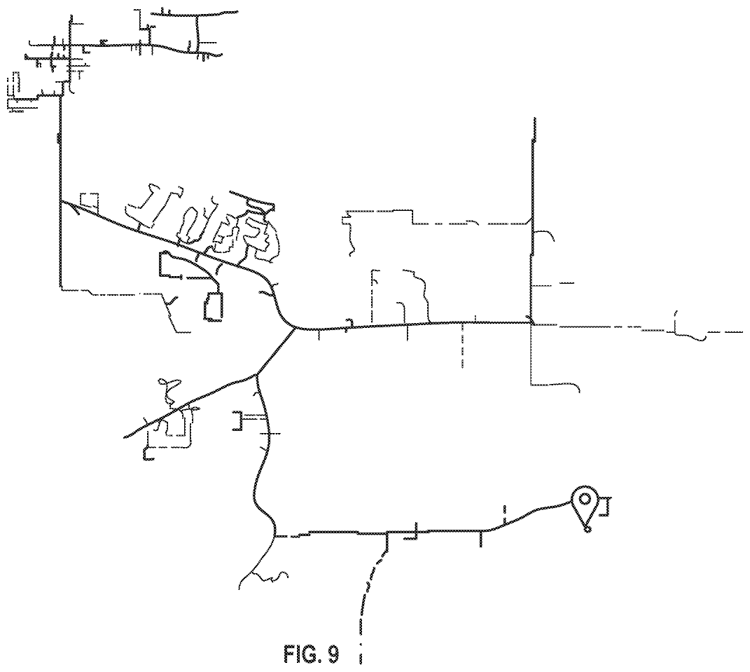

A 461-bus distribution feeder is given as shown in FIG. 9. According to the historical PV interconnection request data in the same neighborhood, the nodal PV adoption comes from the normal distribution with mean=7.36 kW and standard deviation=6.18 kW.

By using the methodology described in steps 1-6, embodiments herein are able to determine the Minimum HC and Maximum HC (with and without backfeed) of this feeder for different “Reasonable” spaces (1, 2, and 3 s levels). The following table summarizes the Minimum and Maximum HC for different reasonable spaces:

TABLE 1
Illustrative example - Min/Max HC

| | | | | Maximum PV | Maximum PV |
|---|---|---|---|---|---|
| Inputs | | | | HC kW/ | HC kW/ |
| | | Confidence | Minimum | Backfeed not | Backfeed is |
| μ_{Nodal}(kW) | σ_{Nodal}(kW) | Interval | PV HC kW | allowed | allowed |
| 7.36 | 6.18 | 3σ | 305.22 | 1,178.60 | 4,395.00 |
| 7.36 | 6.18 | 2σ | 392.98 | 1,178.60 | 4,374.00 |
| 7.36 | 6.18 | 1σ | 504.53 | 1,178.60 | 4,350.00 |

As illustrated in Table 1, using smaller reasonable space (smaller confidence interval) results in smaller feasible space in the optimization problems which results in worse solution (larger Minimum HC and smaller Maximum HC).

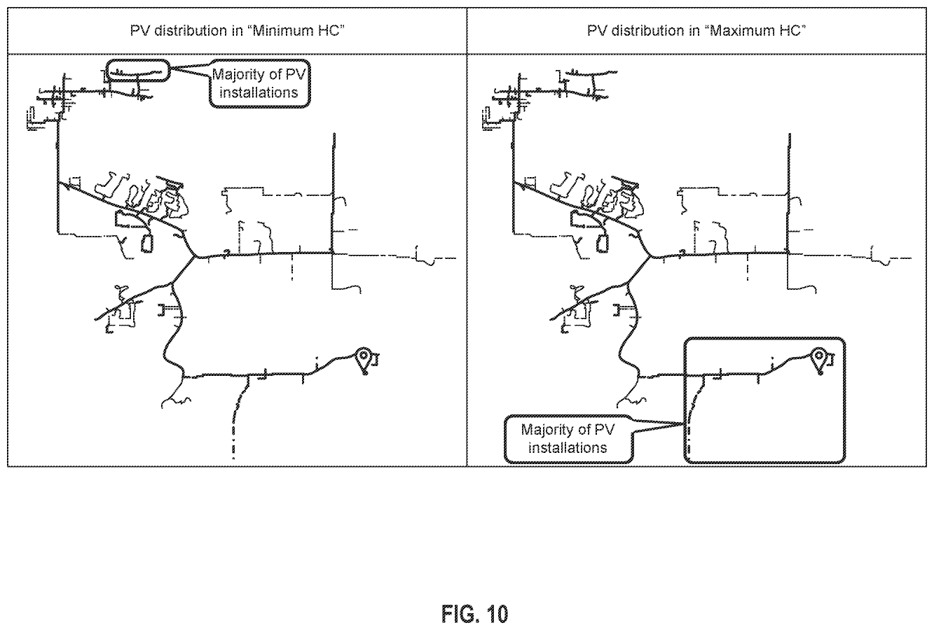

FIG. 10 shows the concentration of the majority of the PV adoption in both Minimum and Maximum HC problems. As shown in FIG. 10, in the Minimum HC problem most of the PV installations are located at the end of the feeder which has the most impact on nodal voltage. In contrast, in the Maximum HC problem PV installations are concentrated closer to the feeder head which has less impact on the nodal voltage.

Increasing Hosting Capacity

Increasing hosting capacity to meet the target HC (THC) by using BESS is formulated as a 2-stage optimization problem (see steps 8 and 9 below).

Step 8 Find the PV Distribution that Meets the HC Target which is Worst Case

The first part of this embodiment is to find the worst-case PV distribution that is within the reasonability constraints. Worst-case is defined as the worst set of grid reliability violations of (4), (5), (6), and (7) Find p^{worst} which

(11) Maximizes violations:

$${max}_{{\underline{p}}^{worst}} [ {W}_{v} * {\underline{u}}^{t} ( {\underline{V}}_{base} + {G}_{p} * {\underline{p}}^{worst} - {\underline{V}}_{max} ) + {W}_{i} * {\underline{u}}^{t} ( {\underline{I}}_{base} + {H}_{p} * {\underline{p}}^{worst} - {\underline{I}}_{max} )$$

where W_{ν} & Wᵢ are weightings for voltage and current violations such that the reasonability constraint (8) ((p^{worst}−pₘ)^{T}Rₚ⁻¹(p^{worst}−pₘ))≤r′ and
(12)u^{t}p^{worst}=Target Hosting Capacity (THC)
   This first part in Step 8 exemplifies the first stage 22-1 of the optimization problem 22 in FIG. 6B according to some embodiments, with p^{worst} exemplifying the worst-case distribution 52 and (11) exemplifying the maximization of the reliability constraints 36 and (8) exemplifying the reasonability constraint 26.

Step 9 Find the Optimal BESS Size that Resolves all the Worst Case Violations without Introducing New Ones

(13)

$${min}_{{\underline{B}}_{cap}} ( {\underline{C}}^{T} {\underline{B}}_{cap} )$$

where C is a cost vector and B_{cap} is the vector of nodal BESS capacity.

Subject to:

Vₘᵢₙ≤V_{base}+Gₚ*(p^{worst}*+b^{p})+G_{q}*b^{q}≤Vₘₐₓ (13)

0≤I_{base}+Hₚ*(p^{worst}+b^{p})+H_{q}*b^{q}≤Iₘₐₓ&(14)

b^{p}^{^{2+b}}^{q}^{^{2≤B}}_{cap}² (15)

where, p^{worst}* is the worst PV distribution determined in “Step 8”. b^{p} and b^{q} are the vector of BESS real and reactive power dispatch (negative dispatch means withdrawal). If Static Var Compensators (SVC) are considered to mitigate the impacts of PV or EV on the circuit, this same formulation applies except that there is no real power component. If PV curtailment on some basis is considered, this is similarly treated.
This second part in step 9 exemplifies the second stage 22-2 in FIG. 6B, with C^{T}B_{cap} exemplifying the objective function 56 and C exemplifying the cost vector 60.

Step 10 Reporting

The worst-case PV distribution to reach the target hosting capacity, the size and/or location and/or cost of optimal BESS required to achieve that hosting capacity, may be reported. Alternatively or additionally, the worst-case voltage and/or current violations may be reported. Reporting may involve, for example, the computing equipment transmitting the reported information to other equipment and/or providing the reported information to one or more components of the computing equipment for display or further processing. The information reported in step 10 may exemplifying the information 34 reported in FIG. 5.

### Illustrative Example—Increasing HC

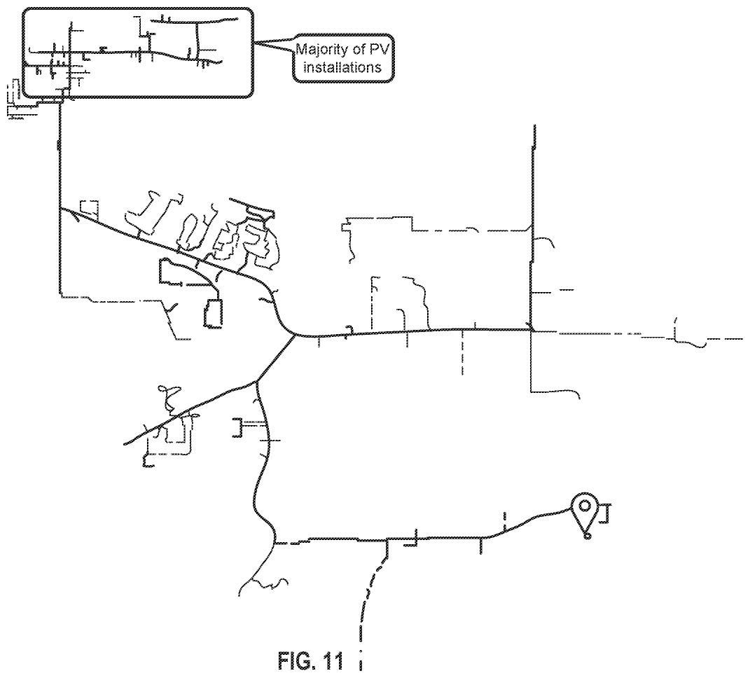

For the same feeder shown in FIG. 9, the optimal BESS solution to meet different Target HC (THC) levels may be determined by using the methodology defined in steps 8 and 9. As described in Step 8, the first stage is determining the worst-case PV distribution within the reasonable space which creates the highest violation. FIG. 11 shows the location of majority of PVs in the worst-case PV distribution.

Table 2 summarizes the Minimum BESS requirements to meet different THC levels (1 MW, 2 MW, 3 MW and 5 MW) for different “Reasonable” spaces (1, 2, and 3 s levels) for PV distribution. Backfeed is allowed in this example.

TABLE 2
Illustrative example - Increasing HC using BESS

| | | | Increasing | | Increasing | | Increasing | | Increasing | |
|---|---|---|---|---|---|---|---|---|---|---|
| | | | Minimum HC | | Minimum HC | | Minimum HC | | Minimum HC | |
| | | | to 1000 kW | | to 2000 kW | | to 3000 kW | | to 5000 kW | |
| | | | Minimum | Minimum | Minimum | Minimum | Minimum | Minimum | Minimum | Minimum |
| Inputs | | | PV HC | Required | PV HC | Required | PV HC | Required | PV HC | Required |
| | | Confidence | kW with | BESS | kW with | BESS | kW with | BESS | kW with | BESS |
| μ_{Nodal} | σ_{Nodal} | Interval | BESS | kVA | BESS | kVA | BESS | kVA | BESS | kVA |
| 7.36 | 6.18 | 3σ | 1,000.00 | 399.18 | 2,000.00 | 1,323.21 | 3,000.00 | 2,199.39 | 5,000.00 | 2,927.62 |
| 7.36 | 6.18 | 2σ | 1,000.00 | 388.34 | 2,000.00 | 1,323.42 | 3,000.00 | 2,168.39 | 5,000.00 | 2,867.90 |
| 7.36 | 6.18 | 1σ | 1,000.00 | 376.01 | 2,000.00 | 1,321.06 | 3,000.00 | 2,135.16 | 5,000.00 | 2,799.40 |

As illustrated in Table 2, using bigger reasonable space (larger confidence interval) results in worst cases which create more severe violation. Therefore, larger BESS is required to alleviate the violation.

External Inputs to the Hosting Capacity Analysis

Some embodiments herein exploit one or more of the following external inputs, e.g., as received by the computing equipment from other equipment:
The circuit model(s) under study, from a distribution planning tool, including limits (ratings) to be used in grid reliability constraints and the base case nodal loads chosen for the hour where PV production is greatest when measured against circuit total load (e.g., Sunday afternoon in May).
The nodal mean and standard deviation of PV adoption. These can be determined using historical adoption data and/or bottom-up adoption propensity analysis.
The nodal limits on battery installation.
The nodal costs of battery installation, including technology costs, installation costs, annualized operating costs including charge/discharge losses, nodal interconnection costs, and nodal siting costs.
Relative weightings of voltage and current violations in the worst-case determination.

Other Applications: EV Hosting Capacity

As described above, the same methodology can be used to determine probabilistic EV Hosting Capacity and best NWA solutions for increasing EV Hosting Capacity.

The reasonability constraint (8) is identical with a change in nomenclature.
(16) ((e−eₘ)^{T}Rₑ⁻¹(e−eₘ))≤r′ where e is EV nodal penetration
   The reliability constraints are identical.
   The objective function is modified to reflect that e is a load where p was an injection.
(17) max(u^{T}e)(find the set of negative numbers e with minimal absolute value)
   Subject to: one element or more of (4) (5) (6) constraints is violated.

The formulation and step wise process for finding optimal NWA deployment to reach a target EV hosting capacity is identical, and the reporting is identical. The base case hour is now a peak hour, typically a weekday late afternoon/early evening in July-September.

According to some embodiments, then, the Hosting Capacity Constraints (hcc) are given by:
Voltage upper limit or V_{base}+ΔV≤Vₘₐₓ or V_{base}+G*p≤Vₘₐₓ (linearized sensitivities)
Line current limit or I_{base}+ΔI≤Iₗᵢₘ or I_{base}+H*p≤Iₗᵢₘ (linearized sensitivities)
for all draws of p in a “reasonable” space
   Given the definition of “reasonable” space—what is the Minimum/Maximum 2 that can be hosted for a given probability space of PV distributions—90%, 95%, 98%, etc, two optimization problems can be stated as follows.

One optimization problem is to minimize “Total amount of EV load” (Decision variables: nodal EV load—e)

### Subject to:

At least one of the following constraints is violated:
   Voltage constraints Vₘᵢₙ≤V_{base}+G*e
   Current constraints I_{base}+H*e≤Iₗᵢₘ
   Backfeed constraints
Reasonable Space constraints (βe^{T}*Rₚ⁻¹*β\vec{e})≤p′ and β\vec{e}=(e−eₘ)
Nodal EV limit (e is negative as is load) −eₗᵢₘ≤e≤0

Another optimization problem is to maximize “Total amount of EV load” (Decision variables: nodal EV load—e)

### Subject to:

Voltage constraints Vmin≤Vbase+G*e
Current constraints Ibase+H*e≤Ilim
Backfeed constraints
Reasonable Space constraints (βeT*Rp−1*βe)≤p′
Nodal EV limit (e is negative as is load)−elim≤e≤0

### Illustrative Example—EV Hosting

For the same 461-bus feeder shown in FIG. 9, the Minimum EV hosting capacity is determined. The nodal EV adoption comes from the normal distribution with mean=7.2 kW and standard deviation=7.2 kW. As illustrated in Table 3, the EV hosting capacity for this feeder is 51.66 kW.

TABLE 3
Illustrative example - EV hosting

| Confidence Interval | 3σ | 2σ | 1σ |
|---|---|---|---|
| μ_{Nodal} | 7.20 | 7.20 | 7.20 |
| σ_{Nodal} | 7.20 | 7.20 | 7.20 |
| Minimum Nodal Load kW | 0.00 | 0.00 | 0.00 |
| Maximum Nodal Load kW | 14.40 | 14.40 | 14.40 |
| Average Nodal Load kW | 0.11 | 0.11 | 0.11 |
| Total Load (Minimum HC) kW | 51.66 | 51.66 | 51.66 |

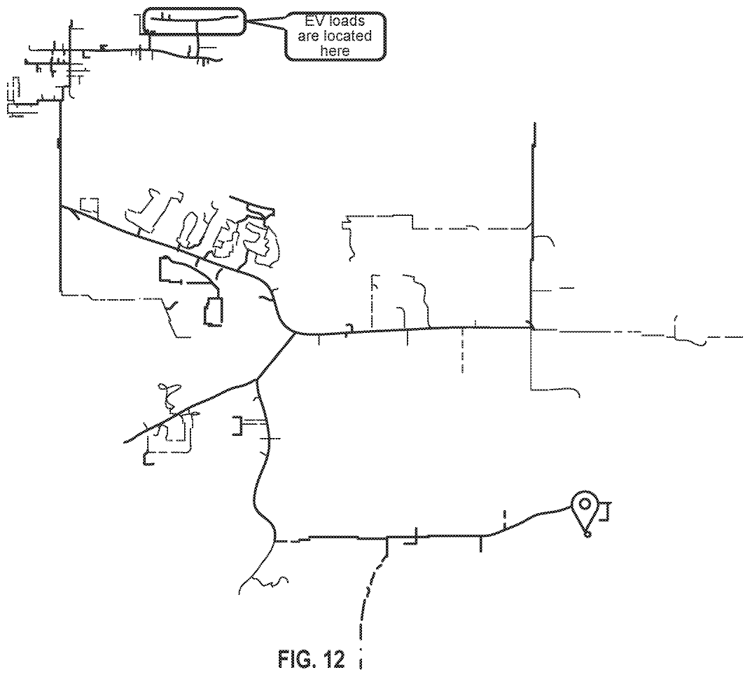

As shown in FIG. 12, EV loads are located at the end of the feeder which has the highest impact on nodal voltage and line current.

The minimum BESS solution to increase the EV hosting capacity to meet the EV hosting capacity target is also examined in this example by using the explained methodology. Table 4 shows the minimum BESS requirements to meet different EV hosting capacity target (0.5 MW, 1 MW and 2 MW) for different reasonable spaces (1, 2, and 3 s levels).

TABLE 4
Illustrative example - increasing EV hosting capacity

| | | | Increasing | | | | Increasing | |
|---|---|---|---|---|---|---|---|---|
| | | | Minimum HC | | Increasing | | Minimum HC | |
| | | | to 500 kW | | Minimum HC | | to 2000 kW | |
| | | | | Minimum | to 1000 kW | | | Minimum |
| | | | Minimum | Required | Minimum | Minimum | Minimum | Required |
| Inputs | | | Load HC | BESS | Load HC | Required | Load HC | BESS |
| | | Confidence | kW with | kVA | kW with | BESS | kW with | kVA |
| μ_{Nodal} | σ_{Nodal} | Interval | BESS | Capacity | BESS | kVA | BESS | Capacity |
| 7.20 | 7.20 | 3σ | 500.00 | 361.49 | 1,000.00 | 598.11 | 2,000.00 | 923.41 |
| 7.20 | 7.20 | 2σ | 500.00 | 361.67 | 1,000.00 | 598.11 | 2,000.00 | 923.51 |
| 7.20 | 7.20 | 1σ | 500.00 | 361.68 | 1,000.00 | 598.11 | 2,000.00 | 923.43 |

Incorporating “Stacked Benefits” and Other DER Technologies

The objective functions for PV and EV increased hosting capacity above incorporate only the cost of the BESS. The cost vectors c can be modified to include any other quantifiable aspects such as energy savings, energy and ancillaries market benefits, emissions reduction, and grid avoided costs. The constraint formulation and optimization procedures are as before.

Some embodiments herein may be extended as described below:

Co-optimizing PV, EV, Electrification, and BESS in various combinations, e.g., cross linking different capacity issues at different hours via the constraints and other things to explore

Adding other Benefit, e.g., Energy (LCOE basis for annual figure), Ancillaries, Emissions, Grid Avoided Costs (via Locational Marginal Value from DERVT).

Adding other Benefits, e.g., this becomes the Foundation for Probabilistic IRP in Distribution.

Integrating Co-optimization of Feeder Upgrade, e.g., via formulation that places a cost on “mho” per mile of conductor.

Integrating Co-optimization of Station Upgrade, e.g., via one model of multiple feeders and a cost of station transformer rating or via simplified model that only looks at station capacity when applicable (as with ESPT).

Applying the probabilistic constraint concept to G&T planning and to integrated G, T, D planning

Making PV production, EV load probabilistic as well as adoption in context of IRP

Extend to sub-transmission and distribution integrated planning (has been plotted with ESPT/DERVT)

Note that, in some embodiments, energy storage broadly refers to any technology that enables power system operators, utilities, developers, or customers to store energy for later use. A battery energy storage system (BESS) is an electrochemical device that charges or collects energy from the grid or a distributed generation (DG) system and then discharges that energy later to provide electricity or other services when needed. BESS can provide grid and customer services, acting as both a load (while charging) and a generation asset (while discharging). Behind-the-meter (BTM) BESS refers to customer-sited stationary storage systems that are connected to the distribution system on the customer's side of the utility's service meter. BTM BESS, along with DG and other grid assets deployed at the distribution level, are broadly included in what is referred to as distributed energy resources (DERs).

Note also that the North American Electric Reliability Corp. (NERC) is the national entity responsible for reliability of the bulk electric system over the continental U.S., Canada and the northern portion of Baja California, Mexico. NERC defines a Distributed Energy Resource (DER) as follows: “A Distributed Energy Resource (DER) is any resource on the distribution system that produces electricity and is not otherwise included in the formal NERC definition of the Bulk Electric System.” A DER in some embodiments herein is as defined by NERC.

DER in such embodiments thereby includes any non-bulk electric system resource-generating unit, multiple generating units at a single location, energy storage facility, or microgrid-located solely within the boundary of any distribution utility, according to NERC. It also includes behind-the-meter generation such as solar photovoltaic, and energy storage facilities or multiple devices at a single location on either the utility or customer's side of the meter, including electric-vehicle charging stations. The DER definition also includes “cogeneration”, which is production of electricity from steam, heat or other energy from a separate process at a resource site. Finally, emergency, stand-by, or back-up generation to meet emergency needs is considered a DER.

In view of the modifications and variations herein, FIG. WW1 depicts a method for distributed energy resource (DER) and/or electrification capacity planning in a power system 10 in accordance with particular embodiments. The method includes obtaining, for each of multiple electrical nodes 16 in a circuit model 14 of the power system 10, parameters 20 of a probability distribution function 18 describing respective probabilities of different amounts of DERs 12 and/or electrification 13 being added at the electrical node 16 in the future (Block 100). The method also includes calculating an existing hosting capacity of the power system 10 and/or infrastructure requirements to achieve a target hosting capacity of the power system 10, by solving an optimization problem 22 that is subject to a reasonability constraint 26 (Block 110). In some embodiments, the reasonability constraint 26 constrains a distribution 28 of amounts of DERs 12 and/or electrification 13 added at respective electrical nodes 16 to being within a space 30 of reasonable distributions which, according to the obtained parameters 20, each are within a defined confidence level 32. In some embodiments, a hosting capacity of the power system 10 is a capacity of the power system 10 to host additional amounts of DERs 12 and/or electrification 13. The method in some embodiments also includes reporting information 34 associated with the existing hosting capacity and/or the infrastructure requirements (Block 120).

In some embodiments, the parameters 20 obtained for each of the electrical nodes 16 describe a probability distribution function 18 for a normal or Gaussian probability distribution.

In some embodiments, said calculating comprises calculating the existing hosting capacity, and said reporting comprises reporting information about the existing hosting capacity.

In some embodiments, solving the optimization problem 22 comprises finding a maximum or minimum value of an objective function 40 in dependence on the reasonability constraint 26 and multiple reliability constraints 36. In this case, the maximum or minimum value of the objective function 40 is a maximum or minimum total amount of DERs 12 and/or electrification 13 added to the power system 13. And the objective function is a function of a decision variable 42. In some embodiments, the decision variable 42 is the distribution 28 of amounts of DERs 12 and/or electrification 13 added at respective electrical nodes 16, and the reliability constraints 36 enforce electrical limits 38 for the circuit model 14.

In some embodiments, finding the maximum or minimum value of the objective function 40 comprises finding the maximum or minimum value of the objective function 40 such that the reasonability constraint 26 is satisfied and at least one of the reliability constraints 36 is violated.

In some embodiments, the method is performed for DER capacity planning in the power system 10, and the objective function 40 is u^{T}p, where u is a vector of 1 s, where p represents the distribution 28 as a vector of values pᵢ, and where pᵢ is an amount of DER 12 added at electrical node i.

In other embodiments, the method is performed for electrification capacity planning in the power system 10. In this case, the objective function 40 is u^{T}e, where u is a vector of 1 s, where e represents the distribution 28 as a vector of values eᵢ, and where et is an amount of electrification 13 added at electrical node i.

In some embodiments, the reasonability constraint is ((p−pₘ)^{T}Rₚ⁻¹(p−pₘ))≤r′, where pₘ is an expected value E(p) of p, where Rₚ is a covariance matrix equal to E((p−pₘ) (p−pₘ)^{T}), and where r′ represents the defined confidence level 32. In other embodiments, the reasonability constraint is ((e−eₘ)^{T}Rₑ⁻¹(e−eₘ))≤r′, where eₘ is an expected value E(e) of e, where Rₑ is a covariance matrix equal to E((e−eₘ)(e−eₘ)^{T}), and where r′ represents the defined confidence level 32.

In some embodiments, solving the optimization problem 22 comprises, for each electrical node 16 and branch in the circuit model 14, solving the optimization problem 22 with a constraint on only that electrical node or branch to obtain an individual maximum or minimum value of the objective function. Solving the optimization problem may then comprise selecting a maximum or minimum value from among the individual maximum or minimum values.

In some embodiments, the information 34 reported includes information describing the existing hosting capacity in terms of a total additional amount of DERs 12 and/or electrification 13 for which the power system 10 has capacity. In other embodiments, the information 34 alternatively or additionally includes information describing a distribution 26 of amounts of DERs 12 and/or electrification 13 added at respective electrical nodes 16 which provides the existing hosting capacity.

In other embodiments, said calculating comprises calculating the infrastructure requirements 54 to achieve the target hosting capacity 50 of the power system 10. In one or more such embodiments, the optimization problem 22 is a two-stage optimization problem.

In some embodiments, solving the optimization problem 22 comprises, in a first stage 22-1 of the optimization problem 22, calculating a worst-case distribution 52 of an amount of DERs 12 and/or electrification 13 added to the power system 10, by calculating the worst-case distribution 52 as a distribution that satisfies the reasonability constraint 26, that maximizes violation of reliability constraints 36, and that achieves the target hosting capacity 50. Here, the reliability constraints 36 enforce electrical limits 38 for the circuit model 14.

In some embodiments, solving the optimization problem 22 then comprises, in a second stage 22-2 of the optimization problem 22, finding infrastructure requirements 54 that minimize an objective function 56 and that resolve the maximized violation of the reliability constraints 36. In this case, the objective function 56 is a function of the infrastructure requirements 54 and a cost vector 60 characterizing costs of the infrastructure requirements 54.

In some embodiments, the reasonability constraint 26 is ((p^{worst}−pₘ)^{T}Rₚ⁻¹(p^{worst}−pₘ))≤r′, where p^{worst} is the worst-case distribution 52, where pₘ is an expected value E(p^{worst}) of p^{worst} where Rₚ is a covariance matrix equal to E((p^{worst}−pₘ) (p^{worst}−pₘ)^{T}), and where r′ represents the defined confidence level 32.

In some embodiments, the cost vector 60 characterizes at least financial costs of the infrastructure requirements 52. In other embodiments, the cost vector alternatively or additionally characterizes at least energy savings attributable to the infrastructure requirements. In yet other embodiments, the cost vector alternatively or additionally characterizes at least energy and ancillaries market benefits of the infrastructure requirements. In still yet other embodiments, the cost vector alternatively or additionally characterizes at least emissions reduction attributable to the infrastructure requirements. In still yet other embodiments, the cost vector alternatively or additionally characterizes at least grid-avoided costs of the infrastructure requirements.

In some embodiments, the information 34 reported includes information describing the worst-case distribution 52. In other embodiments, the information 34 alternatively or additionally includes information describing the maximized violation of the reliability constraints 36. In yet other embodiments, the information 34 alternatively or additionally includes information describing the infrastructure requirements 52.

In some embodiments, the infrastructure requirements 52 include requirements as to a size and/or location of battery energy storage systems, BESSs, in the power system 10.

Alternatively or additionally, in some embodiments, the hosting capacity of the power system is a capacity of the power system to host additional amounts of Photo Voltaic energy resources and/or Electric Vehicle energy resources

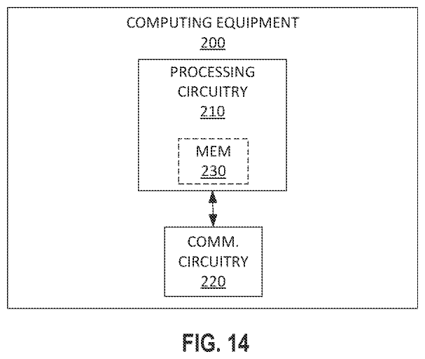

The methodologies described herein may be performed by computing equipment 200, e.g., of a power system 10, as shown in FIG. 14. In one embodiment, for example, the computing equipment 200 comprises processing circuitry 210 configured to perform one or more of the steps herein, e.g., by executing instructions stored in memory 230 of the computing equipment 200. The computing equipment 200 in another embodiment may further comprise communication circuitry 220, e.g., for receiving one or more inputs of one or more of the steps herein.

Alternatively or additionally, the methodologies described herein may be embodied in instructions stored on a non-transitory computer-readable storage medium. In this case, the non-transitory computer-readable storage medium may have stored thereon instructions that, when executed by a processor of computing equipment 200, cause the computing equipment 200 to perform one or more of the steps described herein.

More particularly, the computing equipment 200 described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for carrying out one or more of the techniques described herein, in several embodiments. In embodiments that employ memory, the memory stores program code that, when executed by the one or more processors, carries out the techniques described herein.

Those skilled in the art will also appreciate that embodiments herein further include corresponding computer programs.

A computer program comprises instructions which, when executed on at least one processor of computing equipment 200, cause the computing equipment 200 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of computing equipment, cause the computing equipment to perform as described above.

Embodiments further include a computer program product comprising program code portions for performing the steps of any of the embodiments herein when the computer program product is executed by computing equipment. This computer program product may be stored on a computer readable recording medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole.

What is claimed is:

1. A method for distributed energy resource (DER) and/or electrification capacity planning in a power system, the method comprising:
obtaining, for each of multiple electrical nodes in a circuit model of the power system, parameters of a probability distribution function describing respective probabilities of different amounts of DERs and/or electrification being added at the electrical node in the future;
calculating an existing hosting capacity of the power system and/or infrastructure requirements to achieve a target hosting capacity of the power system, by solving an optimization problem that is subject to a reasonability constraint, wherein the reasonability constraint constrains a distribution of amounts of DERs and/or electrification added at respective electrical nodes to being within a space of reasonable distributions which, according to the obtained parameters, each are within a defined confidence level, wherein a hosting capacity of the power system is a capacity of the power system to host additional amounts of DERs and/or electrification; and
reporting information associated with the existing hosting capacity and/or the infrastructure requirements.

2. The method of claim 1, wherein the parameters obtained for each of the electrical nodes describe a probability distribution function for a normal or Gaussian probability distribution.

3. The method of claim 1, wherein said calculating comprises calculating the existing hosting capacity, and wherein said reporting comprises reporting information about the existing hosting capacity.

4. The method of claim 3, wherein solving the optimization problem comprises finding a maximum or minimum value of an objective function in dependence on the reasonability constraint and multiple reliability constraints, wherein the maximum or minimum value of the objective function is a maximum or minimum total amount of DERs and/or electrification added to the power system, wherein the objective function is a function of a decision variable, wherein the decision variable is the distribution of amounts of DERs and/or electrification added at respective electrical nodes, and wherein the reliability constraints enforce electrical limits for the circuit model.

5. The method of claim 4, wherein finding the maximum or minimum value of the objective function comprises finding the maximum or minimum value of the objective function such that the reasonability constraint is satisfied and at least one of the reliability constraints is violated.

6. The method of claim 5, wherein:
the method is performed by the computing equipment for DER capacity planning in the power system, the objective function is u^{T}p, where u is a vector of 1 s, where p represents the distribution as a vector of values pᵢ, and where pᵢ is an amount of DER added at electrical node i; or
the method is performed by the computing equipment for electrification capacity planning in the power system, the objective function is u^{T}e, where u is a vector of 1 s, where e represents the distribution as a vector of values eᵢ, and where eᵢ is an amount of electrification added at electrical node i.

7. The method of claim 6, wherein the reasonability constraint is:
((p−pₘ)^{T}Rₚ⁻¹(p−pₘ))≤r′, where pₘ is an expected value E(p) of p, where Rₚ is a covariance matrix equal to E((p−pₘ)(p−pₘ)^{T}), and where r′ represents the defined confidence level; or
((e−eₘ)^{T}Rₑ⁻¹(e−eₘ))≤r′, where eₘ is an expected value E(e) of e, where Rₑ is a covariance matrix equal to E((e−eₘ)(e−eₘ)^{T}), and where r′ represents the defined confidence level.

8. The method of claim 3, wherein solving the optimization problem comprise:
for each electrical node and branch in the circuit model, solving the optimization problem with a constraint on only that electrical node or branch to obtain an individual maximum or minimum value of the objective function; and
selecting a maximum or minimum value from among the individual maximum or minimum values.

9. The method of claim 3, wherein the information includes:
information describing the existing hosting capacity in terms of a total additional amount of DERs and/or electrification for which the power system has capacity; and/or
information describing a distribution of amounts of DERs and/or electrification added at respective electrical nodes which provides the existing hosting capacity.

10. The method of claim 1, wherein said calculating comprises calculating the infrastructure requirements to achieve the target hosting capacity of the power system, and wherein said reporting comprises reporting information about the infrastructure requirements.

11. The method of claim 10, wherein the optimization problem is a two-stage optimization problem, wherein solving the optimization problem comprises:
in a first stage of the optimization problem, calculating a worst-case distribution of an amount of DERs and/or electrification added to the power system, by calculating the worst-case distribution as a distribution that satisfies the reasonability constraint, that maximizes violation of reliability constraints, and that achieves the target hosting capacity, wherein the reliability constraints enforce electrical limits for the circuit model; and
in a second stage of the optimization problem, finding infrastructure requirements that minimize an objective function and that resolve the maximized violation of the reliability constraints, wherein the objective function is a function of the infrastructure requirements and a cost vector characterizing costs of the infrastructure requirements.

12. The method of claim 11, wherein the reasonability constraint is:
((p^{worst}−pₘ)^{T}Rₚ⁻¹(p^{worst}−pₘ))≤r′,
where p^{worst} is the worst-case distribution, where pₘ is an expected value E(p^{worst}) of p^{worst},
where Rₚ is a covariance matrix equal to E((p^{worst}−pₘ)(p^{worst}−pₘ)^{T}), and where r′ represents the defined confidence level.

13. The method of claim 11, wherein the cost vector characterizes two or more of:
financial costs of the infrastructure requirements;
energy savings attributable to the infrastructure requirements:
energy and ancillaries market benefits of the infrastructure requirements;
emissions reduction attributable to the infrastructure requirements; and/or
grid-avoided costs of the infrastructure requirements.

14. The method of claim 11, wherein the information includes:
information describing the worst-case distribution;
information describing the maximized violation of the reliability constraints; and/or
information describing the infrastructure requirements.

15. The method of claim 1, wherein the hosting capacity of the power system is a capacity of the power system to host additional amounts of Photo Voltaic energy resources and/or Electric Vehicle energy resources, and/or wherein the infrastructure requirements include requirements as to a size and/or location of battery energy storage systems, BESSs, in the power system.

16. A non-transitory computer readable medium on which is stored instructions which, when executed by computing equipment, cause the computing equipment to:
obtain, for each of multiple electrical nodes in a circuit model of the power system, parameters of a probability distribution function describing respective probabilities of different amounts of DERs and/or electrification being added at the electrical node in the future;
calculate an existing hosting capacity of the power system and/or infrastructure requirements to achieve a target hosting capacity of the power system, by solving an optimization problem that is subject to a reasonability constraint, wherein the reasonability constraint constrains a distribution of amounts of DERs and/or electrification added at respective electrical nodes to being within a space of reasonable distributions which, according to the obtained parameters, each are within a defined confidence level, wherein a hosting capacity of the power system is a capacity of the power system to host additional amounts of DERs and/or electrification; and
report information associated with the existing hosting capacity and/or the infrastructure requirements.

17. The non-transitory computer readable medium of claim 16, wherein the parameters obtained for each of the electrical nodes describe a probability distribution function for a normal or Gaussian probability distribution.

18. The non-transitory computer readable medium of claim 16, wherein the instructions cause the computing equipment to calculate the existing hosting capacity, and to report information about the existing hosting capacity.

19. The non-transitory computer readable medium of claim 18, wherein solving the optimization problem comprises finding a maximum or minimum value of an objective function in dependence on the reasonability constraint and multiple reliability constraints, wherein the maximum or minimum value of the objective function is a maximum or minimum total amount of DERs and/or electrification added to the power system, wherein the objective function is a function of a decision variable, wherein the decision variable is the distribution of amounts of DERs and/or electrification added at respective electrical nodes, and wherein the reliability constraints enforce electrical limits for the circuit model.

20. The non-transitory computer readable medium of claim 19, wherein finding the maximum or minimum value of the objective function comprises finding the minimum value of the objective function such that the reasonability constraint is satisfied and at least one of the reliability constraints is violated.

21. The non-transitory computer readable medium of claim 20, wherein:
the objective function is u^{T}p, where u is a vector of 1 s, where p represents the distribution as a vector of values pᵢ, and where pᵢ is an amount of DER added at electrical node i; or
the objective function is u^{T}e, where u is a vector of 1 s, where e represents the distribution as a vector of values eᵢ, and where eᵢ is an amount of electrification added at electrical node i.

22. The non-transitory computer readable medium of claim 21, wherein the reasonability constraint is:
((p−pₘ)^{T}Rₚ⁻¹(p−pₘ))≤r′, where pₘ is an expected value E(p) of p, where Rₚ is a covariance matrix equal to E((p−pₘ)(p−pₘ)^{T}), and where r′ represents the defined confidence level; or
((e−eₘ)^{T}Rₑ⁻¹(e−eₘ))≤r′ where eₘ is an expected value E(e) of e, where Rₑ is a covariance matrix equal to E((e−eₘ)(e−eₘ)^{T}), and where r′ represents the defined confidence level.

23. The non-transitory computer readable medium of claim 1, wherein solving the optimization problem comprise:
for each electrical node and branch in the circuit model, solving the optimization problem with a constraint on only that electrical node or branch to obtain an individual maximum or minimum value of the objective function; and
selecting a maximum or minimum value from among the individual maximum or minimum values.

24. The non-transitory computer readable medium of claim 18, wherein the information includes:
information describing the existing hosting capacity in terms of a total additional amount of DERs and/or electrification for which the power system has capacity; and/or
information describing a distribution of amounts of DERs and/or electrification added at respective electrical nodes which provides the existing hosting capacity.

25. The non-transitory computer readable medium of claim 16, wherein the instructions cause the computing equipment to calculate the infrastructure requirements to achieve the target hosting capacity of the power system

26. The non-transitory computer readable medium of claim 25, wherein the optimization problem is a two-stage optimization problem, wherein solving the optimization problem comprises:
in a first stage of the optimization problem, calculating a worst-case distribution of an amount of DERs and/or electrification added to the power system, by calculating the worst-case distribution as a distribution that satisfies the reasonability constraint and that maximizes violation of reliability constraints, wherein the reliability constraints enforce electrical limits for the circuit model; and
in a second stage of the optimization problem, finding infrastructure requirements that minimize an objective function and that resolve the maximized violation of the reliability constraints, wherein the objective function is a function of the infrastructure requirements and a cost vector characterizing costs of the infrastructure requirements.

27. The non-transitory computer readable medium of claim 26, wherein the reasonability constraint is:
((p^{worst}−pₘ)^{T}Rₚ⁻¹(p^{worst}−pₘ))≤r′,
where p^{worst} is the worst-case distribution, where pₘ is an expected value E(p^{worst}) of p^{worst},
where Rₚ is a covariance matrix equal to E((p^{worst}−pₘ)(p^{worst}−pₘ)^{T}), and where r′ represents the defined confidence level.

28. The non-transitory computer readable medium of claim 26, wherein the cost vector characterizes two or more of:
financial costs of the infrastructure requirements;
energy savings attributable to the infrastructure requirements:
energy and ancillaries market benefits of the infrastructure requirements;
emissions reduction attributable to the infrastructure requirements; and/or
grid-avoided costs of the infrastructure requirements.

29. The non-transitory computer readable medium of claim 26, wherein the information includes:
information describing the worst-case distribution;
information describing the maximized violation of the reliability constraints; and/or
information describing the infrastructure requirements.

30. The non-transitory computer readable medium of claim 16, wherein the hosting capacity of the power system is a capacity of the power system to host additional amounts of Photo Voltaic energy resources and/or Electric Vehicle energy resources, and/or wherein the infrastructure requirements include requirements as to a size and/or location of battery energy storage systems, BESSs, in the power system.
